(19) United States
(12) Patent Application Publication
(10) Pub. No.: US 2026/0261450 A1
(43) Pub. Date: Sep. 3, 2026

(54) SYSTEM AND METHOD FOR DATA COMMUNICATION AMONG TRANSCEIVER CARDS OVER A COMMON DATA BUS

(71) Applicant: CENTRE FOR DEVELOPMENT OF TELEMATICS, New Delhi (IN)

(72) Inventors: Subarna SADHUHKAN, NEW DELHI (IN); Rinku TAKKAR, NEW DELHI (IN); Nikhil JAIN, NEW DELHI (IN); Digamber YADAV, NEW DELHI (IN); Kashish ANAND, NEW DELHI (IN); Ashok GUPTA, NEW DELHI (IN)

(21) Appl. No.: 19/162,859

(22) PCT Filed: Feb. 28, 2024
(86) PCT No.: PCT/IB2024/051905

§ 371 Date: Sep. 5, 2025

(30) Foreign Application Priority Data
Mar. 7, 2023 (IN) 202311015313

(51) Int. Cl. H04L 12/40

(52) U.S. Cl. CPC H04L 12/4013

(57) ABSTRACT

The present disclosure relates to a communication system including a plurality of transceiver cards configured in respective card slot of a plurality of card slots in a switch chassis. The plurality of transceiver cards are configured to sequentially transmit, based on a predefined transmitting sequence, data over a data bus in a cyclic fashion. When a first transceiver card among the plurality of transceiver cards operates in a transmission mode to transmit the data at a dedicated time slot for a first time-frame, using a clock signal, over the data bus, a set of remaining transceiver cards among plurality of transceiver cards operate in a receiving mode to simultaneously receive the data transmitted over the data bus.

### TECHNICAL FIELD

The present disclosure relates to transceiver cards. More particularly the present disclosure relates a system and method for enabling communication among multiple transceiver cards over a common data bus.

### BACKGROUND

Background description includes information that may be useful in understanding the present invention. It is not an admission that any of the information provided herein is prior art or relevant to the presently claimed invention, or that any publication specifically or implicitly referenced is prior art.

Conventionally, Ethernet/high speed interfaces are used in modular chassis to transmit data between cards via a controller card. Critical applications such as protection switchover, failure alarms, and run-time port configurations in a modular chassis require direct fast communication channels between all line cards. However, conventional systems are not equipped for providing fast communication channels between all line cards.

There is, therefore, a need in the art to provide a system and a method that can mitigate the problems associated with the prior arts.

### OBJECTS OF THE PRESENT DISCLOSURE

Some of the objects of the present disclosure, which at least one embodiment herein satisfy are as listed herein below.

It is an object of the present disclosure to provide a system and method for an asynchronous mode of data transmission between multiple transceiver cards over a single multi-point low voltage differential signaling (M-LVDS) bus.

It is an object of the present disclosure to provide a system and method to provide a multi master multi slave serial communication protocol over a common bus.

It is an object of the present disclosure to provide a system and method to utilize a variable time slot based architecture that is efficient in data transmission.

It is an object of the present disclosure to provide a system and method for utilizing self-synchronization by multiple transceiver cards upon insertion between an ongoing data transmission.

It is an object of the present disclosure to provide a system and method that provides a solution with minimal hardware connectivity requirement.

It is an object of the present disclosure to provide a system and method that performs without the requirement of synchronized clock for all the line cards.

### SUMMARY

The present disclosure relates to transceiver cards. More particularly the present disclosure relates a system and method for enabling communication among multiple transceiver cards over a common data bus.

An aspect of the present disclosure pertains to a communication system including a plurality of transceiver cards, configured in respective card slot of a plurality of card slots in a switch chassis. The plurality of transceiver cards can be configured to sequentially transmit one or more data based on a predefined transmitting sequence over a data bus in a cyclic fashion. When a first transceiver card among the plurality of transceiver cards operates in a transmission mode to transmit the one or more data at a dedicated time slot for a first time-frame, using a clock signal, over the data bus, a set of remaining transceiver cards among plurality of transceiver cards operate in a receiving mode to simultaneously receive the transmitted one or more data over the data bus.

In an embodiment, each of the transceiver cards may include a control unit that is operably coupled with the data bus upon an operative coupling of the corresponding transceiver cards with the switch chassis. The control unit can include a processor or a programmable unit configured to execute a set of instructions stored in a memory, which the set of instructions on execution by the processor can cause the control unit to transmit the one or more data over the data bus in the transmission mode. The control unit can receive the transmitted one or more data from the data bus in the receiving mode.

In an embodiment, the control unit in the receiving mode can be configured to continuously monitor the data bus through which the one or more data is transmitted in a frame by the first transceiver card. The control unit can further detect a start of frame (SOF) of the transmitted one or more data over the data bus. The control unit can select first two consecutive samples of the one or more data after receiving a first number of clock cycles, such that the one or more data is sampled at a middle of the data. The first two consecutive samples can be compared for verifying reception of a data bit correctly. The step of selection of samples can be performed iteratively till the one or more data is received completely. The control unit can upon receiving the one or more data completely, perform a cyclic redundancy check and an end of frame check (EOF) to verify if the received one or more data is error-free.

In an embodiment, upon non-detection of the start of frame, a next transceiver card, according to the pre-defined transmitting sequence, among the set of remaining transceiver cards can be selected to utilize the dedicated time slot and a first-time frame card after waiting for the pre-defined time interval along with its respective first-time frame for transmitting respective data over the data bus using the clock signal.

In an embodiment, the plurality of transceiver cards can be configured in an asynchronous mode.

In an embodiment, the control unit in the receiving mode can be configured to sample the one or more data at a higher rate than a data transmission rate of the first transceiver card and register a plurality of centre sampling points of the one or more data such that the plurality of transceiver cards are synchronized with each other.

In an embodiment, the transmitting sequence can be pre-defined by the switch chassis based on a unique slot identification number of the plurality of card slots.

Yet another aspect of the present disclosure pertains to a method for enabling sequential communication, based on a pre-define transmission sequence, between a plurality of transceiver cards over a data bus where a first transceiver card among the plurality of transceiver cards operate in a transmission mode to transmit the one or more data at a dedicated time slot for a first time-frame, using a clock signal, over the data bus, and a set of remaining transceiver cards among the plurality of transceiver cards operate in a receiving mode to simultaneously receive the transmitted one or more data and the plurality of transceiver cards are configured to be operate in any of a transmission mode and a receiving mode at a time. The method can include continuous monitoring by a control unit having a processor in receiving mode, the data bus through which the one or more data is transmitted in a frame by the first transceiver card. The method further includes detecting, by the control unit, a start of frame (SOF) of the data transmitted over the data bus. The method can include selecting by the control unit first two consecutive samples of the one or more data, after receiving a first number of clock cycles, such that the one or more data is sampled at a middle of the data. The first two consecutive samples can be compared to verify reception of a data bit correctly. The step of selection of samples can be performed iteratively till the one or more data is received completely. The method can include performing by the control unit upon receiving the complete data, a cyclic redundancy check and an end of frame check (EOF) to verify if the received one or more data is error-free.

In an embodiment, the method can include sampling the one or more data at a higher rate than a data transmission rate of the first transceiver card and registering a plurality of centre sampling points of the one or more data such that the plurality of transceiver cards are synchronized with each other.

Various objects, features, aspects, and advantages of the inventive subject matter may become more apparent from the following detailed description of preferred embodiments, along with the accompanying drawing figures in which like numerals represent like components.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure. The diagrams are for illustration only, which thus is not a limitation of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1A illustrates an exemplary representation of a communication system, in accordance with an embodiment of the present disclosure.

FIG. 1B illustrates an exemplary representation of a method for selecting a transceiver card as any of the transmission mode and receiving mode, in accordance with an embodiment of the present disclosure.

FIG. 1C illustrates an exemplary representation of a control unit in receiving mode, in accordance with an embodiment of the present disclosure.

FIG. 2 illustrates an exemplary representation of a module diagram of a control unit of plurality of transceiver cards in the communication system, in accordance with an embodiment of the present disclosure.

FIG. 3 illustrates an exemplary representation of a method for enabling a communication between a plurality of transceiver cards over single data bus, in accordance with an embodiment of the present disclosure.

FIG. 4 illustrates an exemplary computer system to implement the proposed system, in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the scope of the present disclosure as defined by the appended claims.

In the following description, numerous specific details are set forth in order to provide a thorough understanding of embodiments of the present invention. It will be apparent to one skilled in the art that embodiments of the present invention may be practiced without some of these specific details.

The present disclosure relates to transceiver cards. More particularly the present disclosure relates a system and method for enabling communication among multiple transceiver cards over a common data bus.

The present disclosure elaborates upon a communication system including a plurality of transceiver cards, configured in respective card slot of a plurality of card slots in a switch chassis. The plurality of transceiver cards are configured to sequentially transmit, based on a predefined transmitting sequence, one or more data over a data bus in a cyclic fashion. When a first transceiver card among the plurality of transceiver cards operates in a transmission mode to transmit the one or more data at a dedicated time slot for a first time-frame, using a clock signal, over the data bus, and a set of remaining transceiver cards among plurality of transceiver cards operate in a receiving mode to simultaneously receive the transmitted one or more over the data bus.

In an embodiment, each of the transceiver cards can comprise a control unit that is operable to be communicatively configured with the data bus upon operative coupling of the corresponding transceiver cards with the switch chassis. The control unit can comprise a processor configured to execute a set of instruction stored in a memory, which the set of instructions on execution by the processor can cause the control unit to transmit the one or more data over the data bus in the transmission mode. The control unit can further receive the transmitted one or more data from the data bus in the receiving mode.

In an embodiment, the control unit, in the receiving mode, can be configured to continuously monitor the data bus through which the one or more data is transmitted in a frame by the first transceiver card. The control unit can further detect a start of frame (SOF) of the transmitted one or more over the data bus. The control unit can further select first two consecutive samples of the one or more data, after receiving a first number of clock cycles, such that the one or more data is sampled at a middle of the data. The first two consecutive samples are compared to verify reception of a data bit correctly. The step of selection of samples is performed iteratively till the one or more data is received completely. The control unit can further, upon receiving the complete data, perform a cyclic redundancy check and an end of frame check (EOF) to verify that the received one or more data is error-free.

In an embodiment, upon non-detection of the start of frame, a next transceiver card, according to the pre-defined transmitting sequence, among the set of remaining transceiver cards can be selected to utilizes the dedicated time slot and the first-time frame card after waiting for the pre-defined time interval, along with its respective first-time frame, for transmitting respective data over the data bus using the clock signal.

In an embodiment, the plurality of transceiver cards can operate in an asynchronous mode.

The control unit in the receiving mode can be configured to sample the one or more data at a higher rate than a data transmission rate of the first transceiver card and register a plurality of centre sampling points of the one or more data such that the plurality of transceiver cards are synchronized with each other.

In an embodiment, the transmitting sequence can be pre-defined by the switch chassis based on a unique slot identification number of the plurality of card slots.

Yet another embodiment of the present disclosure pertains to a method for enabling sequential communication, based on a pre-define transmission sequence, between a plurality of transceiver cards over a data bus where a first transceiver card among the plurality of transceiver cards operates in a transmission mode to transmit one or more data at a dedicated time slot for a first time-frame, using a clock signal, over the data bus, and a set of remaining transceiver cards among plurality of transceiver cards operate in a receiving mode to simultaneously receive the transmitted one or more data and the plurality of transceiver cards are configured to be operate in any of a transmission mode and a receiving mode at a time. The method includes continuously monitoring, by a control unit having a processor in receiving mode, the data bus through which the one or more data is transmitted in a frame by the first transceiver card. The method further includes detecting, by the control unit, a start of frame (SOF) of the transmitted one or more data over the data bus. The method further includes selecting, by the control unit, first two consecutive samples of the one or more data after receiving a first number of clock cycles, such that the one or more data is sampled at a middle of the data. The first two consecutive samples are compared to verify reception of a data bit correctly. The step of selection of samples is performed iteratively till the one or more data is received completely. The method further includes performing, by the control unit, upon receiving the complete data, a cyclic redundancy check and an end of frame check (EOF) to verify that the received one or more data is error-free.

In an embodiment, the method can include sampling the one or more data at a higher rate than a data transmission rate of the first transceiver card and registering a plurality centre sampling points of the one or more data such that the plurality of transceiver cards are synchronized with each other.

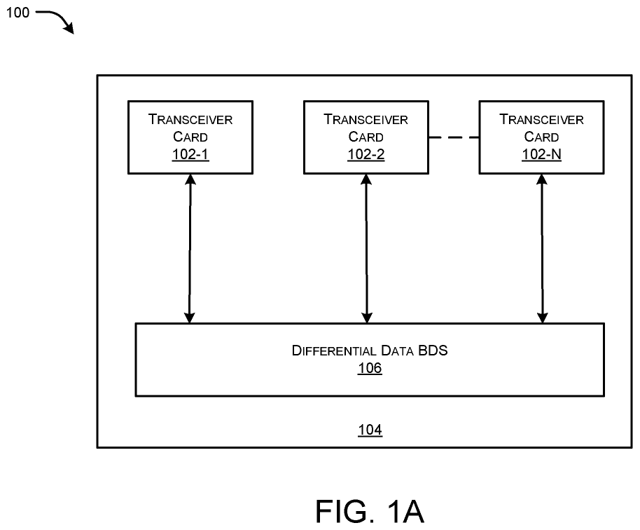

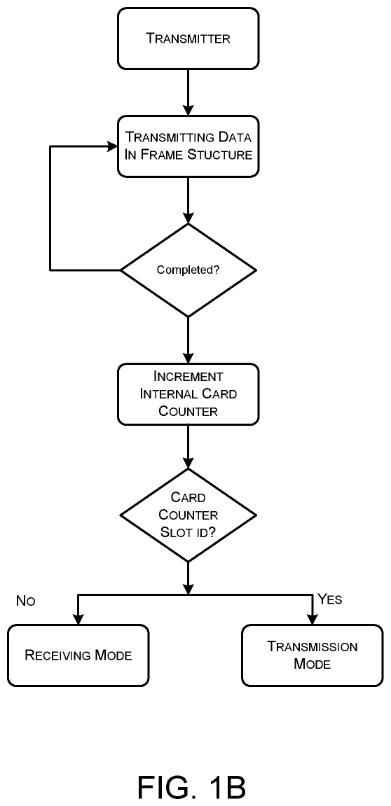

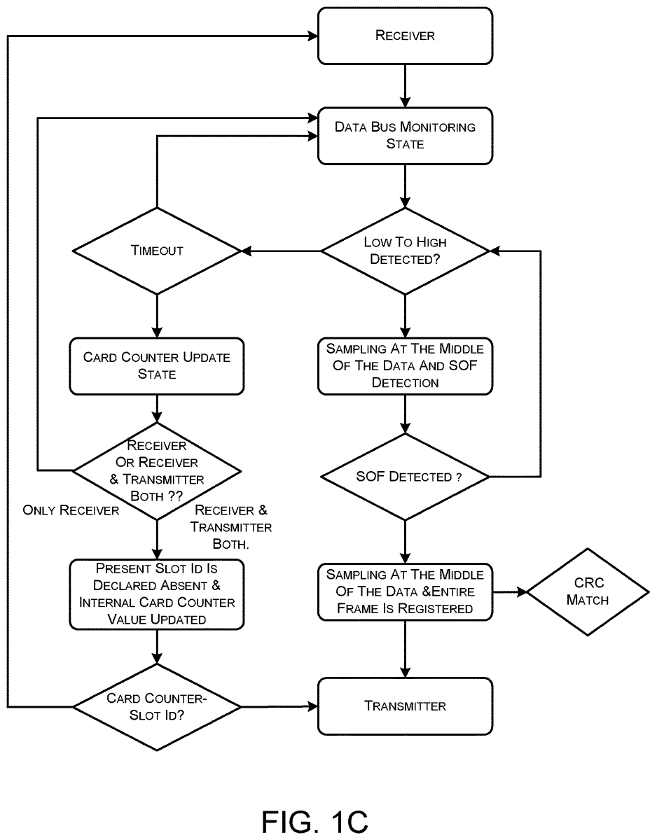

FIG. 1A illustrates an exemplary representation of a communication system, in accordance with an embodiment of the present disclosure.

FIG. 1B illustrates an exemplary representation of a method for selecting a transceiver card as any of the transmission mode and receiving mode, in accordance with an embodiment of the present disclosure.

FIG. 1C illustrates an exemplary representation of a control unit in receiving mode, in accordance with an embodiment of the present disclosure.

As illustrated, a communication system 100 can include a plurality of transceiver cards 102-1, 102-2 . . . 102-N (collectively referred as plurality of transceiver cards 102, hereinafter) configured in respective card slot of a plurality of card slots in a switch chassis 104. The plurality of transceiver cards 102 can be configured to sequentially transmit, based on a predefined transmitting sequence, data over a data bus in a cyclic fashion. The transmitting sequence can be pre-defined by the switch chassis based on a unique slot identification number of the plurality of card slots. The plurality of transceiver cards is configured to act any of a transmitter or a receiver at an instant of time. When a first transceiver card among the plurality of transceiver cards 102 operates in a transmission mode to transmit the data, a set of remaining transceiver cards among plurality of transceiver cards 102 can operate in a receiving mode to simultaneously receive the data transmitted over the data bus 106. The data bus can include but is not limited to a multi-point low voltage differential signaling (M-LVDS) bus.

In an embodiment, each of the plurality of transceiver cards 102 can be configured to sequentially transmit, one at a time, data over the data bus 106 at a dedicated time slot for a first time-frame using a clock signal. The dedicated time slot and the first-time frame can be pre-defined. In an embodiment, each of the plurality of transceiver cards 102 can comprise a control unit that can be operable to be communicatively configured with the data bus upon operative coupling of the corresponding transceiver cards with the switch chassis.

In an embodiment, the control unit 108 can comprise a processor or a controller that can be configured to execute a set of instruction stored in a memory, which the set of instructions on execution by the processor can cause the control unit to transmit the data over the data bus in the transmission mode. The control unit can further receive the transmitted data from the data bus in the receiving mode. The control unit of a respective transceiver card can be configured to transmit respective data over the data bus is a current dedicated slot is meant for the respective transceiver card. This can be identified by comparing a slot ID of the respective transceiver card with a counter that can be used to keep a track of the transmitting sequence. Every time a transceiver card has completed data transmission the counter can be incremented to indicate that a next intended transceiver card can start data transmission, if the counter indicator and the slot ID of the respective transceiver cards does not match, the respective transceiver card can perform in a receiving mode (FIG. 1B).

In an embodiment, the control unit in the receiving mode can be configured to continuously monitor the data bus through which the data is transmitted in a frame by the first transceiver card. The control unit can further detect a start of frame (SOF) of the data transmitted over the data bus. The data can be transmitted in form of data frame. An exemplary data frame structure can be represented as:

### Frame Structure:

| | | | | | | |
|---|---|---|---|---|---|---|
| 0011 | 8 Bit SOF | Own Slot id. | Data | CRC | 8 Bit EOF | IFS |

where,
   SOF: Start of Frame.
   CRC: Cyclic Redundancy Check.
   EOF: End of Frame.
   IFS: Inter Frame Spacing.
      SOF & EOF are completely generic and can be modified depending upon the application. In our implementation, SOF and EOF values are “10100101” and “11011011” respectively. IFS is the time gap between two consecutive frame structures, in our case, IFS is twice the data period. Also based on the requirement of the application IFS can be changed. Data size varies depending on the application and it is also possible to have different data size for different nodes in a single system.

In an embodiment, the control unit can further select first two consecutive samples of the data, after receiving a first number of clock cycles, such that the data is sampled at a middle of the data. The first two consecutive samples are compared to verify reception of data bit correctly. For example, once receiver sequence begins with metastability removal two flip-flop synchronizer circuit & positive edge detection module that waits for data transition from low to high. The clock edge can be marked at which data transition from low to high occurs. Further, the control unit can wait for another 4 cycles to establish sampling in the middle of the data, and takes consecutive two samples and compares them if both the samples are the same then it seems that the data bit is correctly sampled. Further, the control unit can wait for another 7 clock cycles, which ensures the sampling at the middle of the next data, and then the comparison between two consecutively taken samples is done.

The step of selection of samples is performed iteratively till the data is received completely. The control unit can further, upon receiving the complete data, perform cyclic redundancy check and end of frame check (EOF) to verify that the received data is error-free. In an embodiment, upon non-detection of the start of frame (FIG. 1C), a next transceiver card, according to the pre-defined transmitting sequence, among the set of remaining transceiver cards can be selected to utilizes the dedicated time slot and the first-time frame card after waiting for the pre-define time interval, along with its respective first-time frame, for transmitting respective data over the data bus using the clock signal.

In an embodiment, for example, suppose there are three transceiver cards 1, 2, and 3. The transmitting sequence is 1, 2, and 3. At the time when the transceiver card 2 is supposed to transmit data, the transceiver card 3 can monitor the data bus for monitoring the data transmission, in case, when the transceiver card 2 is not present in respective card slot, the transceiver card 3 can start transmitting data over the data bus after waiting for some time. In this case the transceiver card 3 can be allowed to use the first-time frame, dedicated time slot of the transceiver card 2, along with the first-time frame and the dedicated time slot of the transceiver card 3. This can prevent the time wastage which could be there in case the transceiver card 3 would have waited till the dedicated time slot of the transceiver card 2 is over, and start transmission at its own dedicated time slot. Also, in this case the dedicated time slot, and the first-time frame can be utilized by the transceiver card 1, also.

In an embodiment, the set of remaining transceiver cards of the plurality of transceiver cards 102 can be asynchronous and can does not have a common clock signal. The control unit, in the receiving mode, can be configured to sample the data at a higher rate than a data transmission rate of the first transceiver card and registers centre sampling points of the data such that the plurality of transceiver cards are in synchronized with each other. For example: suppose the receiver clock is 8*X Hz and the data rate is X bits/second. So, the receiver section can sample the data at 8 times higher than the data transmission rate. In our design, we have used 77.76 MHz clock as receiver clock and achieved data rate of 9.72 Mbps.

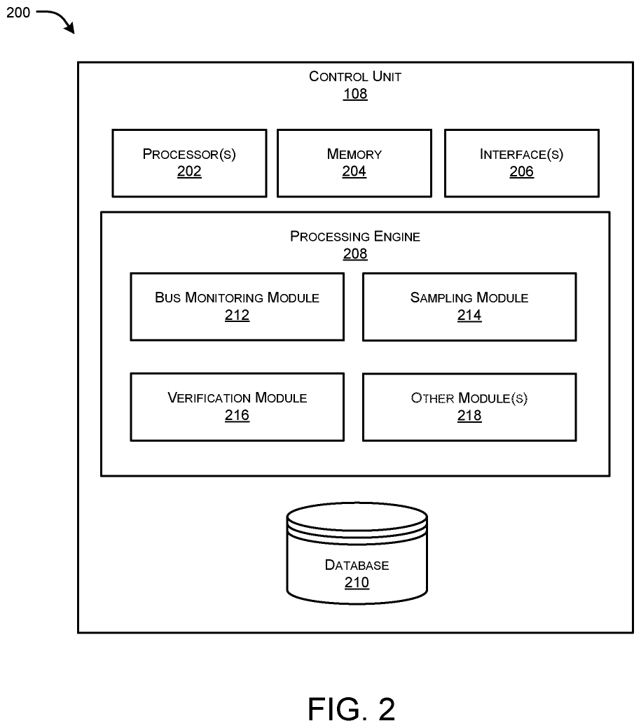

FIG. 2 illustrates an exemplary representation of a module diagram of a control unit of plurality of transceiver cards in the communication system, in accordance with an embodiment of the present disclosure.

As illustrated, module diagram 200 of the control unit 108 can comprise one or more processor(s) 202. The one or more processor(s) 202 can be implemented as one or more microprocessors, microcomputers, microcontrollers, digital signal processors, central processing units, logic circuitries, and/or any devices that manipulate data based on operational instructions. Among other capabilities, one or more processor(s) 202 are configured to fetch and execute computer-readable instructions stored in memory 204 of the control unit 108. The memory 204 can store one or more computer-readable instructions or routines, which can be fetched and executed to create or share the data units over a network service. The memory 204 can comprise any non-transitory storage device including, for example, volatile memory such as RAM, or non-volatile memory such as EPROM, flash memory, and the like.

System 102 can also comprise an interface(s) 206. The interface(s) 206 can comprise a variety of interfaces, for example, interfaces for data input and output devices referred to as I/O devices, storage devices, and the like. The interface(s) 206 can facilitate communication of the control unit 108. The interface(s) 206 can also provide a communication pathway for one or more components of the control unit 108. Examples of such components include, but are not limited to, processing engine(s) 208 and data 210. For example,

The processing engine(s) 208 can be implemented as a combination of hardware and programming (for example, programmable instructions) to implement one or more functionalities of the processing engine(s) 208. In the examples described herein, such combinations of hardware and programming can be implemented in several different ways. For example, the programming for the processing engine(s) 208 can be processor-executable instructions stored on a non-transitory machine-readable storage medium and the hardware for the processing engine(s) 208 can comprise a processing resource (for example, one or more processors), to execute such instructions. In the present examples, the machine-readable storage medium can store instructions that, when executed by the processing resource, implement the processing engine(s) 208. In such examples, control unit 108 can comprise the machine-readable storage medium storing the instructions and the processing resource to execute the instructions, or the machine-readable storage medium can be separate but accessible to control unit 108 and the processing resource. In other examples, the processing engine(s) 208 can be implemented by electronic circuitry.

The data 210 can comprise data that is either stored or generated as a result of functionalities implemented by any of the components of the processing engine(s) 208 or the control unit 108. The system can include a bus monitoring module 212 that can be operatively configured with the M-LVDS bus for detecting start of frame (SOF). If the start of frame is not detected for a pre-define time period a next transceiver card of the plurality of transceiver cards 102 can start transmitting. The next transceiver card can be selected based on the pre-defined transmitting sequence.

In an embodiment, the control unit can further include a sampling module 214 that can be operatively configured with the bus monitoring module 212. The sampling module can be configured to sample the data at a higher rate than a sampling rate of the first transceiver card of the plurality of transceiver cards 102 transmitting the data.

In an embodiment, the control unit can further include a verification module 216 that can be communicatively configured to with the sampling module 214. The verification module 216 can be configured to perform the cyclic and end of frame (EOF) check over the received data to ensure the accuracy of the receiver data.

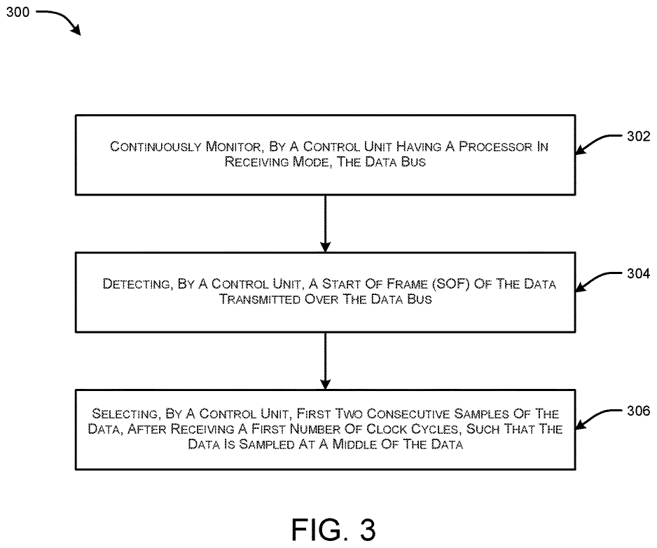

FIG. 3 illustrates an exemplary representation of a method for enabling a communication between a plurality of transceiver cards over single data bus, in accordance with an embodiment of the present disclosure.

Yet another embodiment of the present disclosure pertains to a method 300 for enabling sequential communication, based on a pre-define transmission sequence, between a plurality of transceiver cards over a data bus where a first transceiver card among the plurality of transceiver cards operates in a transmission mode to transmit the data at a dedicated time slot for a first time-frame, using a clock signal, over the data bus, and a set of remaining transceiver cards among plurality of transceiver cards operate in a receiving mode to simultaneously receive the data transmitted and the plurality of transceiver cards are configured to be operate in any of a transmission mode and a receiving mode at a time.

In an embodiment, in step 302, the method 300 can include continuously monitor, by a control unit having a processor in receiving mode, the data bus through which the data is transmitted in a frame by the first transceiver card.

In an embodiment, in step 304, the method 300 can include detecting, by a control unit, a start of frame (SOF) of the data transmitted over the data bus.

In an embodiment, in step 306, the method 300 can include selecting, by a control unit, first two consecutive samples of the data, after receiving a first number of clock cycles, such that the data is sampled at a middle of the data. The first two consecutive samples are compared to verify reception of data bit correctly. The step of selection of samples is performed iteratively till the data is received completely.

In an embodiment, the method 300 can include performing, by a control unit, upon receiving the complete data, perform cyclic redundancy check and end of frame check (EOF) to verify that the received data is error-free.

In an embodiment, the set of remaining transceiver cards may be asynchronous. The method 300 can include sampling the data at a higher rate than a data transmission rate of the first transceiver card and registers centre sampling points of the data such that the plurality of transceiver cards are in synchronized with each other.

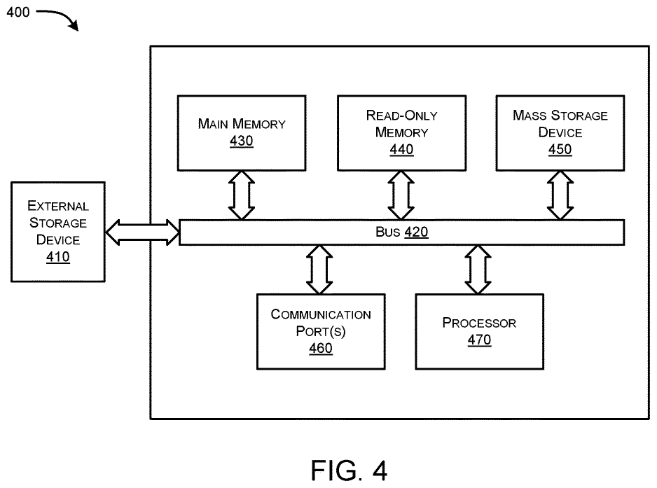

FIG. 4 illustrates an exemplary computer system to implement the proposed system, in accordance with an embodiment of the present disclosure.

As illustrated, a computer system can include an external storage device 410, a bus 420, a main memory 430, a read-only memory 440, a mass storage device 450, a communication port 460, and a processor 470. A person skilled in the art will appreciate that computer system can include more than one processor and communication ports. Processor 470 can include various modules associated with embodiments of the present invention. Communication port 460 can be any of an RS-232 port for use with a modem based dialup connection, a 10/100 Ethernet port, a Gigabit or 10 Gigabit port using copper or fiber, a serial port, a parallel port, or other existing or future ports. Communication port 460 can be chosen depending on a network, such a Local Area Network (LAN), Wide Area Network (WAN), or any network to which computer system connects.

Memory 430 can be Random Access Memory (RAM), or any other dynamic storage device commonly known in the art. Read only memory 440 can be any static storage device(s) e.g., but not limited to, a Programmable Read Only Memory (PROM) chips for storing static information e.g., start-up or BIOS instructions for processor 470. Mass storage 450 can be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), one or more optical discs, Redundant Array of Independent Disks (RAID) storage, e.g. an array of disks (e.g., SATA arrays).

Bus 420 communicatively couples processor(s) 470 with the other memory, storage and communication blocks. Bus 420 can be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 470 to software system. Optionally, operator and administrative interfaces, e.g. a display, keyboard, and a cursor control device, can also be coupled to bus 420 to support direct operator interaction with computer system. Other operator and administrative interfaces can be provided through network connections connected through communication port 460.

Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

While the foregoing describes various embodiments of the invention, other and further embodiments of the invention may be devised without departing from the basic scope thereof. The scope of the invention is determined by the claims that follow. The invention is not limited to the described embodiments, versions, or examples, which are included to enable a person having ordinary skill in the art to make and use the invention when combined with information and knowledge available to the person having ordinary skill in the art.

### Advantages of the Invention

The present disclosure provides a system and method for an asynchronous mode of data transmission between multiple transceiver cards over a multi-point low voltage differential signaling (M-LVDS) bus.

The present disclosure provides a system and method to for enabling a multi master multi slave serial communication protocol over a common bus.

The present disclosure provides a system and method to utilize a variable time slot based architecture that is efficient in data transmission.

The present disclosure provides a system and method for utilizing self-synchronization by multiple transceiver cards upon insertion between an ongoing data transmission.

The present disclosure provides system and method that provides a solution with minimal hardware connectivity requirement.

The present disclosure provides a system and method that performs without the requirement of synchronized clock for all the line cards.

We claim:

1. A communication system, comprising:
a plurality of transceiver cards, configured in respective card slot of a plurality of card slots in a switch chassis, wherein the plurality of transceiver cards are configured to sequentially transmit one or more data, based on a predefined transmitting sequence over a data bus in a cyclic fashion,
wherein when a first transceiver card among the plurality of transceiver cards operates in a transmission mode to transmit the one or more data at a dedicated time slot for a first time-frame, using a clock signal, over the data bus, and a set of remaining transceiver cards among plurality of transceiver cards operate in a receiving mode to simultaneously receive the transmitted one or more data over the data bus wherein the transceiver when in receiving mode continuously monitors the data bus through which the one or more data is transmitted in a frame by the first transceiver card;
detects a start of frame (SOF) of the transmitted one or more data over the data bus;
selects first two consecutive samples of the one or more data, after receiving a first number of clock cycles, such that the one or more data is sampled at a middle of the data, wherein the first two consecutive samples are compared to verify reception of the one or more data bit correctly, and wherein the step of selection of samples is performed iteratively till the one or more data is received completely; and
upon receiving the one or more data completely, performing a cyclic redundancy check and an end of frame check (EOF) to verify whether the received one or more data is error-free.

2. The communication system as claimed in claim 1, wherein each of the transceiver cards comprise a control unit operably coupled to the data bus upon operative coupling of the corresponding transceiver cards with the switch chassis,
wherein the control unit comprises a processor configured to execute a set of instructions stored in a memory, which the set of instructions on execution by the processor causes the control unit to:
transmit the one or more data over the data bus in the transmission mode; and
receive the transmitted one or more data from the data bus in the receiving mode.

3. The communication system as claimed in claim 1, wherein,
upon non-detection of the start of frame, a next transceiver card, according to the pre-defined transmitting sequence, among the set of remaining transceiver cards is selected to utilize the dedicated time slot and a first-time frame card after waiting for a pre-define time interval, along with a respective first-time frame, for transmitting the respective data over the data bus using the clock signal.

4. The communication system as claimed in claim 1, wherein the plurality of transceiver cards are configured in an asynchronous mode.

5. The communication system as claimed in claim 2, wherein the control unit in the receiving mode is configured to:
sample the one or more data at a higher rate than a data transmission rate of the first transceiver card and register a plurality of centre sampling points of the one or more data such that the plurality of transceiver cards are synchronized with each other.

6. The communication system as claimed in claim 1, wherein the transmitting sequence is pre-defined by the switch chassis based on a unique slot identification number of the plurality of card slots.

7. A method for enabling sequential communication, based on a pre-defined transmission sequence, between a plurality of transceiver cards over a data bus where a first transceiver card among the plurality of transceiver cards operates in a transmission mode to transmit one or more data at a dedicated time slot for a first time-frame, using a clock signal, over the data bus, and a set of remaining transceiver cards among the plurality of transceiver cards operate in a receiving mode to simultaneously receive the transmitted one or more data and the plurality of transceiver cards are configured to be operate in any of a transmission mode and a receiving mode at a time, the method include:
continuous monitoring, by a control unit having a processor in receiving mode, the data bus through which the one or more data is transmitted in a frame by the first transceiver card;
detecting, by the control unit, a start of frame (SOF) of the transmitted one or more data over the data bus;
selecting, by the control unit, first two consecutive samples of the one or more data, after receiving a first number of clock cycles, such that the one or more data is sampled at a middle of the data, wherein the first two consecutive samples are compared to verify reception of data bit correctly, wherein the step of selection of samples is performed iteratively till the one or more data is received completely;
performing, by the control unit, upon receiving the one or more data completely, performing a cyclic redundancy check and an end of frame check (EOF) to verify that the received one or more data is error-free.

8. The method as claimed in claim 7, wherein the method includes sampling the one or more data at a higher rate than a data transmission rate of the first transceiver card and registering a plurality of centre sampling points of the one or more data such that the plurality of transceiver cards are synchronized with each other.
